(19) United States
(12) Patent Application Publication
(10) Pub. No.: US 2025/0364721 A1
(43) Pub. Date: Nov. 27, 2025

(54) ANTENNA

(71) Applicant: FLARM Technology AG, Zug (CH)

(72) Inventors: Christophe Fumeaux, Brookfield (AU); Shengjian Chen, Fulham Gardens (AU); Thomas Kaufmann, Hedingen (CH); Urban Maeder, Ebertswil (CH)

(21) Appl. No.: 19/212,096

(22) Filed: May 19, 2025

(30) Foreign Application Priority Data
May 23, 2024 (EP) 24177704.4

(51) Int. Cl. H01Q 9/04; G08G 5/80; H01Q 1/28

(52) U.S. Cl. CPC H01Q 9/0414; G08G 5/80; H01Q 1/28

(57) ABSTRACT

An antenna is provided, including a conductive patch and a conductive feed. The patch has several sides. The conductive feed is arranged at a first side of the patch. The feed is connected to the patch along at least a part of the first side. The feed may be tapered away from the patch. One or more conductive short parts may be provided at the first side of the patch. Each short part may be configured either to connect (the first side of) the patch to ground or to connect the feed to ground. Also provided are a transceiver comprising the antenna, and a method of making the antenna.

### TECHNICAL FIELD

This disclosure relates to an antenna, a transceiver comprising the antenna, and a method of making the antenna. It relates, in particular, to an antenna for a situational-awareness or collision-avoidance system.

### BACKGROUND

Situational awareness and collision avoidance systems are known for gliders and light-aircraft. Several such systems have been developed previously by the present applicant. The systems operate by broadcasting navigation parameters of a craft (for example, its position, heading, and turn rate) in real time to surrounding craft with compatible systems on board. Upon receipt of the navigation parameters of other craft in the vicinity, the system can:
Display the (relative) positions of the other craft on a display screen (typically with the craft in which the system is installed at the centre of the display); and/or.
Compare the navigation parameters of the other craft with its own navigation parameters, to calculate whether there is a risk of imminent collision.

When an imminent risk of collision is detected, the system can alert the pilot—for example by an audio alarm, and/or visible indication on the display screen.

The performance of such a system depends on the ability to send and receive the navigation parameters reliably between craft via radio signals. A suitable antenna is therefore an important part of the system.

### SUMMARY

The inventors have recognised that it would be beneficial to provide an antenna that could be used as an integral component of a situational awareness or collision avoidance system. By “integral”, it is meant that the antenna is mounted internally in a casing of the system. In some examples, the system may therefore be self-contained—with no wired connections extending outside the casing. (However, it should be understood that this is not an essential feature of the solution—in other examples, there may be wired connections for carrying power and/or data signals.

An antenna is provided, including a conductive patch and a conductive feed. The patch has several sides. The conductive feed is arranged at a first side of the patch. The feed is connected to the patch along at least a part of the first side. The feed may be tapered away from the patch. One or more conductive short parts may be provided at the first side of the patch. Each short part may be configured either to connect (the first side of) the patch to ground or to connect the feed to ground. Also provided are a transceiver comprising the antenna, and a method of making the antenna.

According to one aspect, there is provided an antenna comprising:
a conductive patch having a plurality of sides, the plurality of sides including a first side;
a conductive feed arranged at the first side; and
one or more conductive short parts arranged at the first side,
wherein the feed is connected to the patch along at least a part of the first side, and
wherein each of the one or more short parts is configured:
(i) to connect the patch to ground at the first side; and/or
(ii) to connect the feed to ground.

The antenna may be configured to operate as a half-mode shortened monopolar patch antenna.

The sides of the patch may be substantially straight (that is, linear). The patch may be planar.

The one or more short parts may comprise or consist of two short parts. The two short parts may be arranged at opposing sides of the feed (spaced apart along an axis that is parallel to the first side of the patch). The two short parts may be arranged symmetrically about the feed.

The short parts provide a galvanic connection from the patch or the feed to ground—for example, to a ground plane.

Optionally, the other sides of the patch (that is, the sides other than the first side) have no galvanic connections—for example, no galvanic connections to ground and no feed points.

The patch may be arranged in a first plane and the feed may extend out of the first plane.

The feed may be planar and arranged in a second plane.

The first plane and the second plane may intersect at an angle in the range 75° to 105°, optionally 85° to 95°, further optionally about 90°.

The first plane and the second plane may intersect along the first side of the patch.

The feed may have a first width proximal to the patch and a second width distal from the patch, wherein the first width is greater than the second width.

According to another aspect, there is provided an antenna comprising:
a conductive patch having a plurality of sides, the plurality of sides including a first side;
and
a conductive feed arranged at the first side,
wherein the feed is connected to the patch along at least a part of the first side, and
wherein the feed has a first width proximal to the patch and second width distal from the patch, wherein the first width is greater than the second width.

The features of this antenna may be combined with any of the features above or below relating to the antenna of the first aspect.

The first width and the second width may extend parallel to the first side of the patch portion. The first width may be defined as the width of the feed where it meets the patch.

The feed may taper from the first width to the second width. The feed may taper linearly (with a straight edge) or non-linearly (with a curved edge). In some examples, the feed may taper with a shape that is defined at least in part by a spline function.

The patch may be a quadrilateral, optionally substantially rectangular, substantially square, substantially rhomboid-shaped, or substantially rhombus-shaped. The plurality of sides may therefore comprise four sides.

For the avoidance of doubt, the disclosure of “substantially” rectangular and “substantially” square patches is intended to also include disclosure of patches that are rectangular and patches that are square. Likewise, the disclosure of “substantially” rhomboid-shaped and “substantially” rhombus-shaped patches is intended to also include disclosure of patches that are rhomboid-shaped and patches that are rhombus-shaped.

“Rhombus-shaped” means having four sides that have the same length. A square is a rhombus with right angles. “Rhomboid shaped” refers to a parallelogram in which adjacent sides are of unequal lengths and the angles are not right angled.

The antenna may further comprise a support comprising a nonconductive material, wherein the support is arranged to mechanically support the patch.

The support may be formed (partially or entirely) of the nonconductive material. The nonconductive material may be a plastic material, for example, nylon.

The plurality of sides may include a second side, and the support may be arranged at the second side.

The first side and the second side may be opposing sides.

For example, in the case of a rectangular or square patch, the first side and the second side may be opposing parallel sides. The support may be arranged centrally along the second side.

The patch optionally comprises a recessed portion configured to attach to the support. The recessed portion may be recessed relative to a plane of the patch (for example, the “first plane” mentioned above).

The provision of the recessed portion can facilitate attachment of the patch to the support while avoiding increasing a dimension of the antenna. The patch may therefore define one extremity of the antenna. For instance, if the patch is oriented in a horizontal plane in a normal upright orientation of the antenna, the provision of the recessed portion can help to avoid an increase in the height of the antenna. The patch may define an uppermost surface of the antenna.

For example, the recessed portion may have a hole, wherein the recessed portion is configured to attach to the support by threading a screw into the support through the hole. In this case, the recessed portion of the patch may be recessed relative to a major portion of the patch by an amount that is greater than or equal to a protrusion of the head of the screw relative to the recessed portion. This can help to avoid that the head of the screw protrudes proud of the major portion of the patch.

In some examples, the recessed portion may be formed by a recessed tongue at an edge of the patch.

At least one of the feed and the one or more short parts optionally comprises: a tab for insertion in a slot, or other opening, in a circuit board; and a shoulder projecting relative to the tab.

The tab may be provided at a distal end of the feed (and/or a distal end of the one or more short parts). Here “distal” refers to the end furthest from the patch.

The tab may have a first transverse dimension (e.g., width), and the shoulder may have a second transverse dimension (e.g., width) that is larger than the first transverse dimension.

The tab may have a transverse dimension (e.g., width), which may be configured to be less than or equal to a corresponding dimension (e.g., length) of a corresponding slot/opening in the circuit board (wherein the slot/opening is configured to receive the tab).

The shoulder may have a transverse dimension (e.g., width) that is configured to be wider than the corresponding dimension (e.g., length) of the corresponding slot/opening in the circuit board. The shoulder may be configured to stop against the circuit board when the tab is inserted in the slot/opening.

The enlarged/projecting shoulder can offer a simple but accurate way to control the effective dimensions of the antenna. In particular, the distance from the circuit board to the patch may be controlled. This may be advantageous, since the transmission/reception characteristics of the antenna may be sensitive to this distance. This may be the case, for example, if a ground plane for the antenna is formed on the circuit board. In this case, the insertion of the tabs into the slots (openings) in the circuit board, as far as the shoulders, can help to ensure a consistent distance between the patch and the ground plane.

The antenna may be configured to transmit and/or receive in a short range device, hereinafter SRD, band or an industrial, scientific, medical band, hereinafter ISM band.

The SRD band may include at least one channel at 868 MHZ. The ISM band may include at least one channel at 915 MHz. In some examples, the ISM band may be between 902 MHz and 928 MHz. The antenna may be configured to transmit in one or more channels having a bandwidth of between 50 KHz and 150 kHz, optionally about 100 KHz. The antenna may have a length, width, and height. The length and width of the antenna may be defined by a length and width, respectively of the patch. The height of the antenna may be defined by a length of the feed and/or a length of the one or more short parts.

The length of the antenna may be in the range 20 to 70 mm, optionally 30 to 60 mm, optionally 40 to 50 mm, further optionally about 43 mm. The width of the antenna may be in the range 20 to 70 mm, optionally 30 to 60 mm, optionally 40 to 50 mm, further optionally about 43 mm.

The height of the antenna may be in the range 10 to 50 mm, optionally 20 to 40 mm, optionally 25 to 35 mm, further optionally about 30 mm.

All combinations of these ranges (and values) are hereby disclosed. In particular, both the length and the width of the antenna may be in the range 20 to 70 mm, optionally 30 to 60 mm, optionally 40 to 50 mm, further optionally about 44 mm.

In one example, the length and width of the antenna are in the range 40 to 50 mm, and the height is in the range 25 to 35 mm. In particular, the length and width may each be about 44 mm and the height may be about 30 mm.

The patch and the feed may be formed integrally from a single metal sheet. In some examples, the patch, the feed, and the one or more short parts may be formed integrally from the single metal sheet.

Also provided is a method of producing an antenna as summarized above, the method comprising:
providing a sheet of metal comprising a patch portion for forming the patch of the antenna and a feed portion for forming the feed of the antenna; and
bending the sheet of metal at a fold line where the patch portion meets the feed portion, to thereby form the patch of the antenna and the feed of the antenna.

The fold line may define the first side of the patch.

The sheet of metal may have a shape that is formed by cutting or stamping. The sheet of metal may be provided initially in a substantially flat condition.

The metal may have a thickness in the range 0.1 mm to 0.7 mm, optionally 0.2 mm to 0.6 mm, optionally 0.3 mm to 0.5 mm, further optionally about 0.4 mm. (The thickness of the metal may be substantially uniform.)

The metal may comprise one or more of: copper, nickel, and tin. The metal may comprise an alloy of two or more of: copper, nickel, and tin.

The sheet of metal may further comprise one or more short portions for forming one or more respective short parts of the antenna, and, following the bending, the one or more short portions and the feed portion may be arranged in the same plane.

In this way, the short parts can be arranged in the same plane as the feed of the antenna. This can be accomplished by a single bending operation, along a single fold line.

The method may further comprise inserting a tab at the end of one or more of (i) the feed and (ii) the one or more short parts into a respective slot/opening in a circuit board. The circuit board may comprise a ground plane for the antenna.

The method may comprise soldering the tab (or tabs) to the circuit board. The soldering may galvanically couple the tabs of the one or more short parts to the ground plane.

The metal sheet may comprise a tongue at one edge. The method may further comprise bending the tongue to form a recessed portion of the patch. A notch may be defined in the patch, above the recessed, bent tongue.

Further provided is a transceiver comprising:
an antenna as summarized above; and
a battery, or a battery compartment configured to receive a battery.

The transceiver may further comprise a transceiver circuit coupled to the antenna. The transceiver circuit may comprise a transmitter circuit and a receiver circuit. The transceiver circuit may be configured to transmit and receive radio frequency (RF) signals via the antenna. The transceiver circuit may be configured to be powered by the battery.

The transceiver circuit may be configured to transmit and/or receive in a short range device (SRD) band or an industrial, scientific, medical (ISM) band. The SRD band may include at least one channel at 868 MHz. The ISM band may include at least one channel at 915 MHz. In some examples, the ISM band may be between 902 MHz and 928 MHz. The transceiver may be configured to transmit in one or more channels having a bandwidth of between 50 KHz and 150 kHz, optionally about 100 kHz. The transceiver circuit may be configured to implement frequency hopping. In one example, the transceiver circuit is configured to change frequency (change channels) twice per second. The selection of the channels may follow a pseudo random sequence.

The transceiver may conform to the ETSI EN 300 220 standard for short range devices. The patch may be arranged such that the first side is the closest of the plurality of sides to the battery or battery compartment.

The other sides may be further from the battery (or battery compartment) than the first side. A distance from the battery (or battery compartment) to the first side is less than a distance from the battery (or battery compartment) to any of the other sides (of the plurality of sides) of the patch.

In this way, the feed may be oriented towards the battery (or battery compartment). It has been found that this can help to reduce an influence of the battery on the radiation pattern of the antenna. It is believed that orienting the feed towards the battery results in the electric fields of the antenna (which have a maximum at the open end—that is, the side furthest away from the feed side) being the least disturbed by the presence of the (metallic) battery.

The transceiver may further comprise a circuit board. The antenna may be mounted to the circuit board. The circuit board may comprise a ground plane for the antenna. The plane of the patch may be parallel to the ground plane (and accordingly parallel to the circuit board). The feed may be arranged substantially perpendicular to the ground plane.

The transceiver may further comprise one or more other antennas. The one or more other antennas may comprise one or both of: a GNSS antenna; and an antenna for aircraft transponder signals. The antenna for aircraft transponder signals may be a 1090 MHz aircraft transponder receiver antenna, for example. The use of an antenna according to the present disclosure, together with one or more other antennas in the transceiver, may help to reduce cross coupling between the various antennas.

The battery (or battery compartment) may be mounted in fixed relation to the circuit board. The transceiver may further comprise a support for mechanically supporting (and, for example, spacing) a part of the antenna relative to the circuit board. The support may comprise a pillar or tube of a nonconductive material—for example, a plastic material, such as nylon. One end of the support may be attached to a recessed portion of the patch (as described previously above).

The battery (or battery compartment), circuit board, antenna and support may be contained in a casing or housing.

The transceiver may be configured for use in a situational awareness or collision avoidance system.

A situational awareness system may provide an indication of surrounding traffic—in particular, an indication of other vehicles in the vicinity using the situational awareness system. A collision avoidance system may provide an alarm to alert a user (e.g., pilot or driver of a vehicle) of a risk of imminent collision with another vehicle—in particular, another vehicle using the collision avoidance system.

The situational awareness or collision avoidance system may be configured for installation in a vehicle. In some examples, the situational awareness or collision avoidance system may be an aviation situational awareness or collision avoidance system, configured for installation in an aerial vehicle. The aerial vehicle may be a light aircraft, glider, or helicopter, for example. In some examples, the situational awareness or collision avoidance system may be a ground-based situational awareness or collision avoidance system, configured for installation in a land vehicle. The land vehicle may be an offroad vehicle, optionally a mining vehicle, such as a haul truck, excavator, pickup truck or other vehicle used for ground resource extraction.

The system may be configured to transmit first data comprising the position (and optionally heading, turn rate and velocity) of the vehicle, via the antenna, to other vehicles in the vicinity. It may be configured to receive, via the antenna, second data comprising the positions (and optionally headings, turn rates and velocities) of the other vehicles. (Here, it should be understood that the “vicinity” depends on the ranges of the transceivers concerned.) The collision avoidance system may be configured to identify (based on the first data and the second data) any of the other vehicles that is on a collision course with the vehicle in which the system is installed.

Accordingly, there is also disclosed a situational awareness or collision avoidance system for installation in a vehicle (optionally an aerial vehicle), the system comprising:
a transceiver as summarized above;
a positioning subsystem, configured to determine a position (and optionally heading, turn rate and velocity) of the vehicle in which the system is installed; and
a processor, configured to
   obtain, from the transceiver, the position (and optionally heading, turn rate and velocity) of at least one other vehicle; and
   identify, based on the positions (and optionally headings, turn rate and velocity) whether said at least one other vehicle is at risk of colliding with the vehicle in which the system is installed.

The system may further comprise an interface configured to communicate information about potential collision risks to a pilot of the vehicle. The interface may comprise a visual and/or auditory interface.

The positioning subsystem may comprise a Global Navigation Satellite System (GNSS) receiver.

All components of the collision avoidance system may be integrated in a single casing or housing. That is, all components, including the antenna, may be internal to the casing or housing.

### BRIEF DESCRIPTION OF THE DRAWINGS

The invention will now be described by way of example with reference to the accompanying drawings, in which:

FIG. 1 is a perspective view of an exemplary antenna according to the present disclosure, from above;

FIG. 2 a perspective view of the antenna of FIG. 1 from below;

FIG. 3 shows the antenna of FIG. 1 installed in a transceiver;

FIG. 4 is a block diagram of an exemplary collision avoidance system incorporating the antenna of FIG. 1;

FIG. 5 is a plot showing a 2-D gain pattern of the antenna of FIG. 1; and

FIG. 6 is a plot illustrating a reflection coefficient of the antenna of FIG. 1 as a function of frequency.

It should be noted that these figures are diagrammatic and not drawn to scale. Relative dimensions and proportions of parts of these figures have been shown exaggerated or reduced in size, for the sake of clarity and convenience in the drawings.

### DETAILED DESCRIPTION

The examples described below relate to aviation situational awareness and collision avoidance. However, the inventors have recognised that their solution may also be appliable in other contexts—for example, in ground-based applications such as open cast mining.

Situational awareness and/or collision avoidance systems are useful in scenarios in which different vehicles are moving in an environment without well-defined routes to follow (e.g. roads, “lanes”, or “corridors”) and/or without traffic controls (e.g., give way signs, traffic lights, or air traffic control).

In some cases, the vehicles involved may be difficult to see (at least from a safe distance) because of their relatively high speed and relatively small size. This may be the case for gliders or light aircraft, for example. In some cases, the nature of the vehicle may be such that the driver/pilot may have limited visibility of the surroundings. This may be the case for haul trucks or excavators in the context of open cast mining, for example, as well as for aerial vehicles.

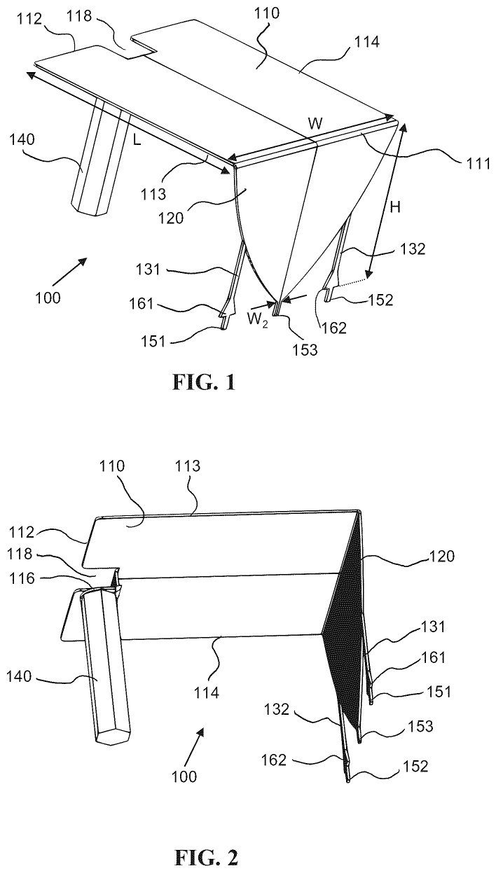

FIGS. 1 and 2 show an antenna according to an example of the present disclosure, from two different perspectives. The antenna of this example consists of a conductive patch 110, a tapered conductive feed 120, and two conductive short parts 131, 132. This antenna is configured as a half-mode shortened monopolar patch antenna.

The patch 110 is a planar patch having four sides-a first side 111, a second side 112, a third side 113, and a fourth side 114. The patch is indicated as having a width W (along the first side and the second side) and a length L (along the third side and the fourth side). In this example the length L and width W are the same. The first and second sides 111, 112 are parallel, straight, opposing sides. The third and fourth sides 113, 114 are, likewise, parallel, straight, opposing sides. The first and second sides are arranged perpendicular to the third and fourth sides. Therefore, the patch of the present example is square-shaped.

The feed 120 is galvanically connected to the patch 110 along the entirety of the first side 111. The feed 120 is planar and is arranged perpendicular to the patch 110. Therefore, when the patch 110 extends in a horizontal plane (as it does in a normal upright orientation of the antenna), the feed 120 extends in a vertical plane. The feed 120 tapers from a maximum width W, at the corner where it is connected to the first side of the patch 110, to a minimum width W2, at a portion of the feed distal from the patch. In this example, the feed 120 tapers continuously, with a curved edge defined by a spline function. The feed 120 is symmetric about a centre line extending from the first side 111 of the patch to the narrow end of the feed. This means that the two opposing edges of the feed 120 are mirror symmetric, defined by the same spline function.

At the distal (bottom) end of the feed 120, a tab 153 is provided. The tab 153 is configured for insertion into a corresponding slot (or other opening) in a printed circuit board (PCB) (not shown in FIGS. 1 and 2) to which the antenna will be mounted. The tab 153 may be soldered in place at the back of the circuit board. In the present example, the tab forms a rectangular extension from the distal end of the tapered feed. The rectangular shape of the tab 153 is defined by two opposing parallel side edges, and a straight end edge, which is perpendicular to the side edges.

The tab 153 has the same width W2 as the narrow distal end of the tapered feed 120. When the tab 153 is inserted into its intended slot/opening in the PCB, the tapered feed prevents over-insertion of the tab, because the widening of the tapered feed causes it to stop against the upper surface of the PCB. The slot/opening in the PCB has a dimension (for example, length or diameter) that is slightly longer than the width W2 of the tab 153. In other words, the slot/opening is large enough to accept the tab 153. However, the slot/opening is small enough that it cannot accept the width of the tapered feed above (that is, proximal of) the tab 153. In some examples, the opening may be provided by a cylindrical via in the PCB.

Each of the two short parts 131, 132 in this example comprises a conductive strip that has a length greater than its width. Each short part 131, 132 is galvanically connected to the tapered feed 120 at a point partway along the respective side edge of the feed 120. The short parts 131, 132 are arranged symmetrically about the centreline of the feed 120. Each short part 131, 132 is configured to connect the respective edge of the feed 120 to ground—for example, to a ground plane provided on the PCB.

In the present example, the short parts 131, 132 extend vertically downwards from the respective opposing side edges of the feed 120. Each short part 131, 132 is connected to the respective edge of the tapered feed at a proximal end of the short part. At an opposing, distal end of the short part, an arrangement is provided for attaching the short part to the PCB and providing a galvanic connection to ground. Specifically, each short part comprises a tab 151, 152 that is configured for insertion into a corresponding slot in the PCB. These tabs 151, 152 have a rectangular shape, similar to the tab 153 at the distal end of the feed. The rectangular shape is defined by two opposing parallel side edges, and a straight end edge, which is perpendicular to the side edges.

Immediately adjacent to each tab 151, 152 (at a proximal side of the tab, opposite to the straight end edge of the tab) a projecting shoulder 161, 162 is provided in the respective short part 131, 132. The projecting shoulders 161, 162 are wider than the rectangular tabs 151, 152. They are configured to stop against the upper surface of the PCB when the tabs 151, 152 are inserted into their intended slots in the PCB. The slots in the PCB for receiving the tabs 151, 152 have a length that is slightly longer than the width of each tab 151, 152. In other words, the slot is long enough to accept the respective tab 151, 152. However, the length of each slot is less than width of the projecting shoulder 161, 162. In other words, the slot is short enough that it cannot accept the width of the shoulder 161, 162. In this way, the projecting shoulders 161, 162 prevent over-insertion of the tabs 151, 152 into their respective slots in the PCB.

Each projecting shoulder 161, 162 defines a straight edge that is configured to engage against the upper surface of the PCB. In the present example, the straight edge extends from both opposing sides of the strip forming the short part. Proximal of the shoulder, the width of the short part reduces linearly to the nominal width of the short part. This nominal width is maintained over the remaining length of the short part, until it reaches the edge of the tapered feed 120. In this arrangement, the shoulder can be understood as being defined by the base of a triangular segment that is superimposed on the strip forming the short part. The two bottom corners of the triangle project from the parallel sides of the strip-shaped short part.

As explained above, the tabs 151, 152, 153 can be used to connect the respective portions of the antenna physically and electrically (galvanically) to the PCB. The wider portions (that is, the wider portion of the feed 120, and the shoulders 161, 162) proximal of the tabs 151, 152, 153 stop against the upper surface of the PCB. This can offer a simple but reliable and accurate way to control the height H of the antenna above the PCB. Since the PCB provides a ground plane for the antenna, this helps to ensure accurate control of the height of the antenna above the ground plane.

It should be understood from the foregoing description that the height H of the antenna is equal to the length of the tapered feed 120 (measured along its centreline, from the first side of the patch 110 to the narrowest width W2 of the feed, where it meets the PCB).

A conductive track on the PCB may provide a transmission line for coupling signals to and from the antenna, via the tab 153 at the distal end of the tapered feed. The PCB may also provide a ground plane for the antenna. The short parts 131, 132 may be coupled to the ground plane via the tabs 151, 152.

To further stabilise the antenna 100, it is supported at a position that is spaced laterally from the first side 111 of the patch 110. In particular, in the present example, the patch 110 is configured to be fixed to a support 140 at the second edge 112 of the patch 110. As shown in FIGS. 1 and 2, the support 140 is arranged centrally along the second side 112 of the patch 110, in this example. The support is provided in the form of a hollow nylon tube or post.

To facilitate the attachment of the patch 110 to the support 140, the patch 110 is provided with a recessed portion 116, configured to attach to the support 140. The recessed portion 116 is recessed below the plane of the patch. (The recessed portion is recessed below the plane of the patch in the same sense that the feed 120 extends below the plane of the patch in a normal upright orientation of the antenna). The recessed portion has a hole, which is configured to receive a screw (not shown in FIGS. 1 and 2). The screw is configured to thread into the top of the support 140 to fix the recessed portion 116 to the support 140. The screw is preferably formed of a nonconductive material—for example, nylon.

The use of the recessed portion 116 helps to prevent the head of the screw projecting above the plane of the patch 110. In the present example, the recessed portion 116 is recessed to a depth below the patch 110 that is greater than the height of the head of the screw. This means that the top of the head of the screw remains below the level of the patch 110. An arrangement like this can help to reduce the overall physical height of the antenna—or at least can help to avoid an increase in height. The radiation characteristics of the antenna will typically depend on the height H; therefore, the desired radiation characteristics may dictate this dimension. By using the recessed portion 116 to avoid any undesired further increase in the height of the antenna, examples according to the present disclosure can allow the overall height of the antenna to be kept to a minimum, for a given set of desired radiation characteristics.

According to the present example, a notch 118 is formed in the middle of the second edge 112 of the patch 110. The notch defines a substantially rectangular shape, with two parallel straight sides terminating in a straight end. The recessed portion 116 is formed by a tongue connected to the straight end of the notch 118. A proximal portion of the tongue projects downward from the patch 110 (perpendicular to the patch 110, in the present example). A distal portion of the tongue extends parallel to the plane of the patch 110. The distal portion is therefore perpendicular to the proximal portion. The hole for receiving the screw, mentioned previously, is provided in the distal portion of the tongue.

The tongue is configured such that the support 140 and the screw (not shown in FIGS. 1-2) are positioned below the notch 118. No part of the tongue (or the support or the screw) projects beyond the second edge 12 of the patch 110 in a direction parallel to the plane of the patch (that is, the horizontal plane, as illustrated). In other words, no part of the tongue (or the support or the screw) projects beyond the second edge 12 of the patch 110 in a plan view of the antenna.

The antenna 100 of the present example is configured to transmit and receive radio signals in a range from 868 MHz to 930 MHz. This range includes (for some geographic regions) an SRD band at 868 MHz and (for other geographic regions) an ISM band in the range 902 MHz to 928 MHz.

The dimensions of the antenna are chosen with this frequency range in mind. The length and width of the square patch are both 43 mm (L=W=43 mm). The height H of the antenna is 30 mm.

The antenna of the present example is formed from a single sheet of metal. This single sheet of metal provides all the conductive parts of the antenna, including: the patch 110; the tapered feed 120 (including the tab 153); the short parts 131, 132 (including the tabs 151, 152 and the shoulders 161, 162); and the tongue that forms the recessed portion 116.

A method making the antenna of FIGS. 1 and 2 will now be described. The sheet of metal is initially provided as a blank in a flat condition. The outline shape of the blank may be defined by cutting or stamping it from a larger sheet of metal. In the present example, the metal sheet forming the blank is made of an alloy of copper, nickel, and tin. This helps reduce corrosion while also facilitating soldered connections to the antenna. The metal sheet has a thickness of 0.4 mm. The metal blank includes a patch portion for forming the patch 110 and a feed portion for forming the tapered feed 120. The metal blank further includes two short portions for forming the respective short parts 131, 132, and a tongue portion for forming the tongue that provides the recessed portion 116.

To form the antenna, the metal blank is bent to an angle of 90° along a fold line where the patch portion meets the feed portion. The fold line corresponds to the first side 111 of the patch 110. The bending of the metal blank orients the feed 120 at right angles to the plane of the patch 110. The short parts 131, 132 remain in the same plane as the feed 120. The recessed portion 116 is formed by bending the proximal portion of the tongue at 90° to the patch 110, in the same direction as the feed 120, and bending the distal portion of the tongue at 90° to the proximal portion, so that the distal portion of the tongue is parallel to the plane of the patch 110.

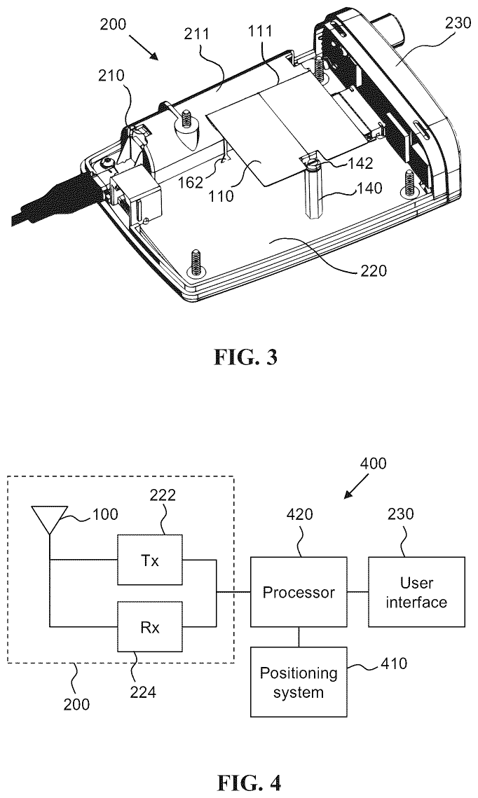

FIG. 3 shows the antenna of FIGS. 1 and 2 installed in a transceiver 200. In addition to the antenna, the transceiver comprises a battery 210 installed in a battery compartment 211. The battery compartment 211 and the antenna 100 are both mounted to a circuit board 220. The tabs 151, 152, 153 are inserted in corresponding slots in the circuit board 220. Only the second short part 132 is visible in the perspective drawing of FIG. 3. The tab 152 at the end of this short part 132 is hidden within and below the circuit board 220. However, the triangular segment forming the shoulder 162 is visible where it stops against the upper surface of the circuit board 220. The nylon support 140 is also mounted to the circuit board 220. The recessed portion of the patch 110 is fixed to the top of the support 140 by a nylon screw 142.

The circuit board 220 provides a ground plane for the antenna. The tabs 151 and 152 (hidden from view in FIG. 3) are galvanically connected to the ground plane by solder joints. The circuit board 220 also provides a feed track for connecting the antenna to a transceiver circuit (not shown explicitly in FIG. 3). The tab 153 at the distal end of the tapered feed 120 is galvanically connected to the feed track by another solder joint. The space between the patch 110 and the circuit board 220 is filled with air. Although not shown in FIG. 3, the electronic components of the transceiver circuit may also be mounted to the circuit board 220. Additional electronic components may be connected to the circuit board. For example, FIG. 3 shows a user interface 230 configured to receive control input from the user and to communicate output information to the user. The user interface 230 is arranged at one end face of the transceiver. One or more processors may also be connected to or mounted on the circuit board.

As shown in FIG. 3, the antenna 100 is arranged with the first side 111 of the patch 110 (and therefore also the tapered feed 120) oriented toward the battery compartment 211. It has been found that this arrangement can help to reduce the effect of the battery on the radiation pattern of the antenna. The antenna 100 is also spaced from the electronics of the user interface 230, to help minimise any interaction between these electronics and the antenna.

The transceiver 200 of FIG. 3 forms part of a collision avoidance system 400. This collision avoidance system 400 is illustrated in the simplified block diagram of FIG. 4. The collision avoidance system comprises the transceiver 200, including a transceiver circuit that comprises transmitter circuit 222 and receiver circuit 224. The collision avoidance system 400 further includes: a positioning system 410; a processor 420; and the user interface 230.

The transmitter and receiver circuits 222, 224 are connected to the antenna 100. They are also connected to the processor 420. The processor 420 is also connected to the positioning system 410 and to the user interface 230.

The processor 420 is configured to receive, from the positioning system 410, navigation parameters describing the position, velocity, and turn rate of the vehicle in which the collision avoidance system is installed. The positioning system 410 of the present example includes a global navigation satellite system (GNSS) receiver and an inertial measurement unit (IMU). In this example, the GNSS receiver is a GPS receiver. In the present example, the positioning system 410 is provided externally, connected by a wired connection to the transceiver unit. The other components of the system are integrated into the transceiver unit—that is, they are mounted in or on a casing of the transceiver unit.

The receiver circuit 224 is configured to receive (via the antenna 100) radio signals from similar collision avoidance systems installed in other vehicles. These received signals contain the navigation parameters of the other vehicles. This data is decoded by the processor 420 and used to determine the relative positions and headings of the other vehicles, relative to the vehicle in which the collision avoidance system 400 is installed. The processor analyses this data in order to detect any risk of an impending collision. When the processor determines that the vehicle is on a collision course with another vehicle (and a collision is likely to occur within a predetermined threshold time, unless evasive action is taken), it alerts the user via the user interface 230.

The processor 420 also encodes the navigation parameters provided by the positioning system 410, for transmission to other vehicles. The transmitter circuit 222 is configured to broadcast (via the antenna 100) radio signals containing these navigation parameters to the collision avoidance systems of the other vehicles.

The user interface 230 includes controls (such as buttons, switches, and/or knobs) for receiving user input and a display screen for communicating the positions and headings of nearby vehicles to the user. The user interface 230 may also include a speaker, for generating an audible alarm to warn the user of a potential impending collision.

An antenna according to examples of the present disclosure can provide a relatively compact, relatively low-profile antenna, with desirable radiation characteristics, and good bandwidth. The desirable radiation characteristics include: a gain pattern that is omnidirectional at least in the horizontal plane; a gain of approximately ˜0 dBi over the whole band of interest; vertical polarisation and/or low horizontal polarisation. The radiation characteristics are relatively insensitive to the effect of surrounding conductive (for example, metallic) parts. For instance, the radiation characteristics are influenced only to a small extent by the presence or absence of the battery 210.

It should be noted that the antenna is also relatively easy to manufacture, which helps to reduce manufacturing costs. Its simple construction is robust, having good mechanical stability and vibration tolerance.

This makes the antenna well suited for use as an integrated antenna in transmitter/receiver/transceiver units. In particular, it may be well suited for use in a transceiver for a situational awareness/collision avoidance system, such as the example described above. In this context, an integrated antenna according to the present disclosure may have particular advantages, compared with an external antenna. Whereas an external antenna may occupy additional space and may be more fragile, an internal, integrated antenna can help to minimise the space occupied by the transceiver unit, while also protecting the antenna within a casing of the transceiver unit.

The various features of the presently described antenna combine synergistically to provide these benefits. Nevertheless, without wishing to be bound by theory, it is believed that certain features contribute in particular ways. The configuration of the antenna as a monopolar patch may assist in achieving the desired radiation characteristics and the low profile (low height H) of the antenna. The provision of the short parts 131, 132 may assist in reducing the size of the antenna (for a given operating frequency band). The configuration of the antenna as a half-mode antenna may assist in reducing the area of the antenna. The use of the tapered feed may help to increase the bandwidth of the antenna.

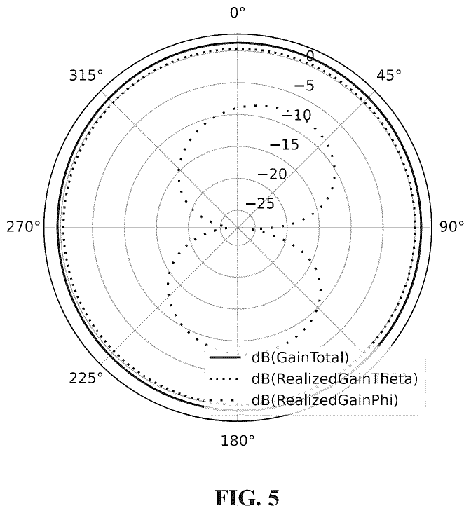

FIG. 5 shows an exemplary 2D gain pattern for the antenna of FIGS. 1-2, in the horizontal plane. The plot shows the horizontal simulated gains at 868 MHz. That is, it is the gain patterns viewed from the top. The total gain (depicted with a solid line) is the magnitude of the gain—that is, both horizontal and vertical polarization. The realized gain with theta polarization (depicted by the outer broken line) is the gain, including mismatch losses (hence realized) of the vertically polarized component. The realized gain with phi polarization is (depicted by the inner broken line) the same, but for horizontal polarization. In other words, the second line (RealizedGainTheta—the outer broken line) is the desired gain including mismatch losses. The angle 0° corresponds to the first side 111 of the patch 110. It can be seen that the gain pattern is substantially omnidirectional, as desired.

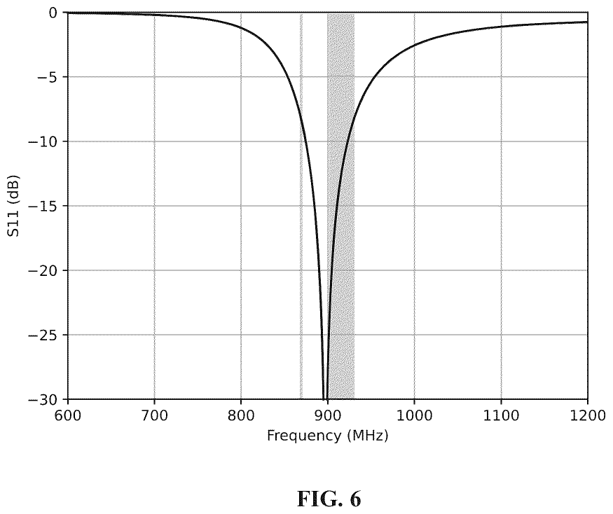

FIG. 6 shows a plot of the reflection coefficient S11 of the antenna with respect to frequency. The reflection coefficient S11 describes how much power is reflected from the antenna at a given frequency. A value of S11=0 dB means that all the power input to the antenna is reflected at the frequency in question. Accordingly, the “valley” or “trough” in the graph at 900 MHz indicates that the antenna radiates and receives most effectively at this bandwidth. The grey shaded vertical bars indicate the desired frequency bands.

It should be understood that the examples above illustrate rather than limit the present disclosure, and that those skilled in the art will be able to design many alternative embodiments without departing from the scope of the appended claims.

For instance, in the antenna 100 of FIGS. 1-2, the feed 120 was connected to the patch 110 along the entirety of the first side 111 of the patch 110. In other examples, the feed might not be connected to the patch along the entirety of the first side.

For the antenna 100 of FIGS. 1-2, the tab 153 at the distal (bottom) end of the feed was described as having a rectangular shape with two opposing parallel side edges and a straight end edge. The corners where the side edges meet the end edge may be rounded. Alternatively, the (entire) end of the tab may have a rounded shape—that is, the end edge may have no straight portion. The rounding may aid insertion of the tab in the respective slot in the PCB. The tabs 151 and 152 of the short parts may be rounded in similar ways to the tab 153 of the feed.

The tabs 151 and 152 of the short parts may have a length that is (slightly) shorter than the length of the tab 153 of the feed. This may help to simplify manufacturing. The tab 153 can be inserted into the PCB first, followed by the tabs 151 and 152.

In some examples, the short parts might be connected (directly, galvanically) to the first side of the patch, instead of being connected to respective edges of the tapered feed.

In some examples, the patch might not be square. The patch may or may not have a quadrilateral shape—it may have a greater or lesser number of sides. When the patch is a quadrilateral, it may have the shape of a rhombus, or a rhomboid, or a rectangle, for example. In other examples, the support could be configured differently and/or formed of a different material.

In the antenna 100 of FIGS. 1-2, the tapered feed 120 tapered with a curved edge defined by a spline function. In other examples, the tapered feed may have a different curved edge, or it may taper linearly with a straight edge.

In the collision avoidance system 400 of FIG. 4, the positioning system 410 was provided externally to the transceiver 200. In other examples, the positioning system may be internal to the transceiver. Therefore, the transceiver may incorporate the components of a GNSS receiver, including a GNSS antenna.

Alternatively or in addition, the transceiver may incorporate one or more other antennas. For instance, the transceiver may comprise an aircraft transponder signal receiver. This may be a separate receiver chip that can decode transponder signals (such as Mode-S and ADS-B signals) transmitted by other aircraft. In one example, a 1090 MHz aircraft transponder receiver antenna is provided in the transceiver.

The design of the antenna of present disclosure need not be influenced by the presence of such antennas (for example, a GNSS antenna and/or an aircraft transponder receiver antenna). Advantageously, it has been found that patch antennas according to the present disclosure can exhibit relatively low cross-coupling to antennas such as these, which may coexist together in the transceiver.

Although the description above focused on the example of a situational awareness or collision avoidance system, the scope of the present disclosure is not limited in this respect. Examples according to the present disclosure can be used to advantage in other applications requiring a low-profile antenna, optionally integrated with a transmitter or receiver.

The word “comprising” does not exclude the presence of elements or steps other than those listed in a claim. The word “a” or “an” preceding an element does not exclude the presence of a plurality of such elements. The embodiments may be implemented by means of hardware comprising several distinct elements. In a device claim enumerating several means, several of these means may be embodied by one and the same item of hardware. The mere fact that certain measures are recited in mutually different dependent claims does not indicate that a combination of these measures cannot be used to advantage. Furthermore in the appended claims, lists comprising “at least one of: A; B; and C” should be interpreted as (A and/or B) and/or C.

Furthermore in general, the various embodiments may be implemented in hardware or special purpose circuits, software, logic or any combination thereof. For example, some aspects may be implemented in hardware, while other aspects may be implemented in firmware or software which may be executed by a controller, microprocessor or other computing device, although these are not limiting examples. While various aspects described herein may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The examples described herein may be implemented by computer software executable by a data processor of the apparatus, such as in the processor entity, or by hardware, or by a combination of software and hardware. Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD.

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general purpose computers, special purpose computers, microprocessors, digital signal processors (DSPs), application specific integrated circuits (ASIC), gate level circuits and processors based on multi-core processor architecture, as non-limiting examples.

1. An antenna comprising:
a conductive patch having a plurality of sides, the plurality of sides including a first side;
a conductive feed arranged at the first side; and
one or more conductive short parts arranged at the first side,
wherein the feed is connected to the patch along at least a part of the first side, and wherein each of the one or more short parts is configured:
(i) to connect the patch to ground at the first side; and/or
(ii) to connect the feed to ground.

2. The antenna of claim 1, wherein the patch is arranged in a first plane and the feed extends out of the first plane.

3. The antenna of claim 2, wherein the feed is planar and arranged in a second plane.

4. The antenna of claim 3, wherein the first plane and the second plane intersect at an angle in the range 75° to 105°.

5. The antenna of claim 1, wherein the feed has a first width (W) proximal to the patch and second width (W2) distal from the patch, wherein the first width (W) is greater than the second width (W2).

6. The antenna of claim 5, wherein the feed tapers from the first width (W) to the second width (W2).

7. The antenna of claim 1, wherein the patch is a quadrilateral, optionally substantially rectangular, substantially square, substantially rhomboid-shaped, or substantially rhombus-shaped.

8. The antenna of claim 1, further comprising a support comprising a nonconductive material, wherein the support is arranged to mechanically support the patch.

9. The antenna of claim 8, wherein the plurality of sides includes a second side, and wherein the support is arranged at the second side.

10. The antenna claim 8, wherein the first side and the second side are opposing sides.

11. The antenna of claim 8, wherein the patch comprises a recessed portion configured to attach to the support.

12. The antenna of claim 1, wherein at least one of the feed and the one or more short parts comprises:
a tab for insertion in a slot in a circuit board; and
a shoulder projecting relative to the tab.

13. The antenna of claim 1, configured to transmit and/or receive in a short range device, hereinafter SRD, band or an industrial, scientific, medical band, hereinafter ISM band.

14. The antenna of claim 1, wherein the patch and the feed are formed integrally from a single metal sheet.

15. The antenna of claim 14, wherein the patch, the feed, and the one or more short parts are formed integrally from the single metal sheet.

16. A method of producing the antenna of claim 14, the method comprising:
providing a sheet of metal comprising a patch portion for forming the patch of the antenna and a feed portion for forming the feed of the antenna; and
bending the sheet of metal at a fold line where the patch portion meets the feed portion, to thereby form the patch of the antenna and the feed of the antenna.

17. The method of claim 16, wherein the sheet of metal further comprises one or more short portions for forming one or more respective short parts of the antenna, and wherein, following the bending, the one or more short portions and the feed portion are arranged in the same plane.

18. A transceiver comprising:
an antenna according to claim 1; and
a battery or a battery compartment configured to receive a battery.

19. The transceiver of claim 18, wherein the patch is arranged such that the first side is the closest of the plurality of sides to the battery or battery compartment.

20. The transceiver of claim 18, wherein the transceiver is configured for use in a situational awareness or collision avoidance system.
